(19) United States
(12) Patent Application Publication
(10) Pub. No.: US 2018/0113074 A1
(43) Pub. Date: Apr. 26, 2018

(54) Light Emission Measuring Device

(71) Applicant: Siemens Aktiengesellschaft, Muenchen (DE)

(72) Inventors: Alexander Michael Gigler, Untermeitingen (DE); Harry Hedler, Germering (DE); Remigiusz Pastusiak, Muenchen (DE); Anton Schick, Velden (DE)

(73) Assignee: Siemens Aktiengesellschaft, Muenchen (DE)

(21) Appl. No.: 15/566,009

(22) PCT Filed: Apr. 30, 2015
(86) PCT No.: PCT/EP2015/059513

§ 371 Date: Oct. 12, 2017

(51) Int. Cl. G01N 21/63; G01J 3/02

(52) U.S. Cl. CPC G01N 21/63; G01N 2201/0636; G01J 3/0208; G01J 3/0229

(57) ABSTRACT

The present disclosure relates to measuring light emission. The teachings thereof may be embodied in emission-measuring devices. For example, a device may include: a sample region; an illumination unit for irradiating the sample region and a sample positioned therein; and a radiation detector. The illumination unit may include: a radiation source; a first dispersive element arranged downstream, decomposing the radiation into spectral components; a first micromirror field arranged downstream; and a second dispersive element arranged downstream of the first micromirror field. The second dispersive element may unify spectral components selected by the first micromirrror field into a common excitation beam.

### CROSS-REFERENCE TO RELATED APPLICATIONS

This application is a U.S. National Stage Application of International Application No. PCT/EP2015/059513 filed Apr. 30, 2016, the contents of which are hereby incorporated by reference in their entirety.

### TECHNICAL FIELD

The present disclosure relates to measuring light emission. The teachings thereof may be embodied in emission-measuring devices and/or methods for measuring the light emission of a sample using an emission-measuring device.

### BACKGROUND

Emission-measuring devices may include emission spectrometers or emission microscopes. In known emission spectrometers, a broadband light source is typically used to irradiate a sample, with the radiation spectrum of the light source overlapping with at least one absorption band of the sample. As a result of the absorption of the light, an emission that is spectrally displaced in relation to the absorption wavelength is excited in the sample, said emission then, under decomposition into its spectral components, is detected by a detection unit in a wavelength-dependent manner. By way of example, such an emission can be fluorescence emission, photoluminescence emission, or phosphorescence emission. In the aforementioned emission mechanisms, some of the energy received by the sample during the light absorption is dissipated without radiation, and so the emitted radiation has been spectrally changed in the direction of the longer wavelength radiation. Alternatively, an emission spectrometer can be used to analyze the Raman scattering of a sample. Here too, there is a spectral change between exciting and emitting radiation.

In order to excite, in as targeted a manner as possible, the light emission of the sample to be measured, the exciting radiation may overlap to the greatest possible extent with the absorption bands of the sample. In this case, additional spectral components in the excitation light beam interfere with the measurement since the longer wavelength components of the excitation beam may cover the emission to be measured. To prevent this, different spectrally selective absorption filters may be used for different samples to filter out the unwanted spectral components, in particular the longer wavelength spectral components, of the excitation light.

For accurate detection and spectral analysis of the emitted light, some systems largely filter out the wavelengths of the radiation used for exciting the emission because, otherwise, the partly very weak emission bands can be covered by a strong background signal. To achieve a good signal-to-noise ratio of the measurement and a high spectral resolution, components of the exciting radiation that have a shorter wavelength in comparison with the emission bands are likewise filtered out by optical absorption filters.

In a similar way to the emission spectrometers described above, a sample may be excited to emit by a short wavelength illumination unit in emission microscopy and the radiation emitted by the sample thereupon is imaged onto an image plane in such a way that a spatial distribution of the emission in the different regions of the sample is made visible. Instead of a wavelength-dependent measurement of the emission spectrum as in the case of an emission spectrometer, spatial imaging of the emission centers thus is achieved by an emission microscope. The imaging of fluorescing regions by a fluorescence microscope is particularly widespread here. In principle, the two methods of emission spectroscopy and emission microscopy also can be combined with one another in principle.

### SUMMARY

The emission spectrometers and emission microscopes of the prior art require macroscopic optical components (in the form of spectrally selective filters) to be moved and interchanged with one another for the purposes of a filtering of the excitation radiation that is matched to the sample to measured and a filtering of the radiation to be detected that is matched to the excitation spectrum. The interchange of these optical components requires a continuous, relatively complicated conversion of the measuring device dependent on the sample to be analyzed. Firstly, this can be accompanied by a readjustment of the remaining optical components after each conversion in order nevertheless to achieve a high measurement quality. Secondly, the spatial requirements in the measuring device are very high overall for the different optical filters that should be brought into the beam path, either alternatively or else in combination, for the various configurations.

The teachings of the present disclosure may be embodied in an emission-measuring device that overcomes the aforementioned disadvantages. In particular, an emission-measuring device which has a simpler, space-saving design, which is more easily adaptable and/or which is more universally usable should be provided. For example, a system may comprise a sample region, an illumination unit for irradiating a sample that is positionable in the sample region, and a detection unit for detecting the radiation that is emitted by the sample using a radiation detector.

For example, an emission-measuring device (1) may comprise: a sample region (3), an illumination unit (7) for irradiating a sample (5) that is positionable in the sample region (3), and a detection unit (35) for detecting the radiation (31) that is emitted by the sample (5) using a radiation detector (47). The illumination unit (7) has a radiation source (9), a first dispersive element (15) that is arranged downstream of the radiation source (9) in the beam direction, for decomposing the radiation into its spectral components (λ₁-λ₆), a first micromirror field (17) that is arranged downstream of the first dispersive element (15) in the beam direction, for selecting spectral components (λ₂), and a second dispersive element (21) that is arranged downstream of the first micromirror field (17) in the beam direction, for unifying the selected spectral components (λ₂) in a common excitation beam (25).

In some embodiments, the illumination unit (7) has at least one focusing unit (13, 23) which is arranged between the radiation source (9) and the first dispersive element (15) in the beam direction and/or arranged between the second dispersive element (21) and the sample region (3) in the beam direction.

In some embodiments, the detection unit (35) has a third dispersive element (41) that is arranged downstream of the sample region (3) in the beam direction, for decomposing the emitted radiation (31) into its spectral components (λ₂-λ₅), a second micromirror field (43) that is arranged downstream of the third dispersive element (41) in the beam direction, for selecting individual spectral components (λ₃-λ₅), and a radiation detector (47) that is arranged downstream of the second micromirror field (43) in the beam direction.

In some embodiments, the detection unit (35) has at least one focusing unit (39, 45) which is arranged between the sample region (3) and the third dispersive element (41) in the beam direction and/or arranged between the second micromirror field (43) and the radiation detector (47) in the beam direction.

In some embodiments, the radiation detector (47) has only a single sensor channel.

In some embodiments, the radiation detector (47) has a sensor field that is pixelated in one or two dimensions.

In some embodiments, the illumination unit (7) and/or the detection unit (35) is free from spectrally selecting optical absorption filters.

Some embodiments may include methods for measuring light emission using an emission-measuring device (1) as described above, characterized by selecting the spectral composition of the excitation beam (25) by activating and/or deactivating the individual micromirrors of the first micromirror field (17).

In some embodiments, a single contiguous portion of spectral components of the radiation is selected by the first micromirror field (17) and the remaining radiation is coupled out of the beam path or a single contiguous portion of spectral components of the radiation is coupled out of the beam path by the first micromirror field (17) and the remaining radiation is selected.

In some embodiments, all short wavelength spectral components of the radiation up to a set threshold of the wavelength are selected by the first micromirror field (17) and the remaining radiation is coupled out of the beam path or all long wavelength spectral components above a set threshold of the wavelength are selected by the first micromirror field (17) and the remaining radiation is coupled out of the beam path.

In some embodiments, the radiation emitted by the sample is spectrally selected by means of a second micromirror field that is arranged in the detection unit by activating and/or deactivating the individual micromirrors.

In some embodiments, a selection pattern of the spectral components selected by the first micromirror field (17) is complementary to a selection pattern of the spectral components selected by the second micromirror field (43), at least in a portion of the wavelength spectrum.

In some embodiments, a reconfiguration of the emission-measuring device (1) for a different wavelength range of the radiation exciting the emission and/or a different wavelength range of the emitted radiation is effectuated without moving macroscopic optical components.

In some embodiments, a partial selection of predetermined spectral components is effectuated by repeated switching between an activated state and a deactivated state of mirrors of the first and/or second micromirror field (17, 43).

In some embodiments, a partial selection of predetermined spectral components is effectuated by selecting a predetermined fraction of the micromirrors in a line or column of a two-dimensional first and/or second micromirror field (17, 43) that is assigned to the respective spectral component.

### BRIEF DESCRIPTION OF THE DRAWINGS

Below, the teachings are further described on the basis of a few exemplary embodiments, with reference being made to the attached drawings; in said drawings:

FIG. 1 shows a schematic illustration of the beam path in an emission-measuring device according to the teachings of the present disclosure;

FIG. 2 shows a schematic illustration of the beam path in an emission-measuring device according to the teachings of the present disclosure;

FIG. 3 shows a schematic illustration of an optical filter unit according to the teachings of the present disclosure;

FIG. 4 shows a schematic illustration of an optical filter unit according to the teachings of the present disclosure;

FIG. 5 shows a schematic illustration of an optical filter unit according to the teachings of the present disclosure; and

FIG. 6 shows a schematic illustration of an optical filter unit according to the teachings of the present disclosure.

### DETAILED DESCRIPTION

In some embodiments, an emission-measuring device has a sample region, an illumination unit for irradiating a sample that is positionable in the sample region, and a detection unit for detecting the radiation that is emitted by the sample using a radiation detector. In some embodiments, the illumination unit comprises a radiation source, a first dispersive element that is arranged downstream of the radiation source in the beam direction, for decomposing the radiation into its spectral components, a first micromirror field that is arranged downstream of the first dispersive element in the beam direction, for selecting spectral components, and a second dispersive element that is arranged downstream of the first micromirror field in the beam direction, for unifying the selected spectral components in a common excitation beam.

The aforementioned beam direction should respectively be understood to mean the local optical beam direction in the emission-measuring device, independently of whether the spatial orientation of the beam path changes during the beam propagation. The described spatial arrangement of the individual optical components arranged “upstream” or “downstream” of another component in the beam direction therefore should not specify a position along a continuous, uniform direction but only a sequence of passage of optical rays along an optical beam path which, overall, leads from the radiation source over the sample to the radiation detector, expressed differently an optical “upstream” or “downstream” in the beam path.

In some embodiments, the emission-measuring device provides an adaptation of the spectral properties of the excitation beam to the optical properties of the sample to be measured by selecting the spectral components by means of the first micromirror field, without this requiring spectrally selective absorption filters in the beam path. Instead, the spectral adaptation of the excitation spectrum to the sample and/or to the predetermined measurement object can be effectuated without this requiring the movement of macroscopic optical components. Instead of inserting and removing the optical filters, a spectral selection can be effectuated significantly easier, in a more space saving manner, in a more automated manner and also more precisely by way of the first micromirror field.

In some embodiments, the radiation emitted by the radiation source first reaches the first dispersive element, by means of which it is spatially decomposed into its various spectral components. That is to say, the first dispersive element changes the direction and/or spatial location of the partial beams belonging to the individual spectral components and, as a consequence, spatially fans open the radiation. In some embodiments, after the first dispersive element, the radiation reaches the first micromirror field which facilitates the selection of the various spectral components by way of the position of the individual mirrors. In general, the dispersive elements may comprise an optical prism or an optical grating.

In some embodiments, the first micromirror field comprises a regular arrangement of a multiplicity of small optical mirrors. In some embodiments, the micromirrors can be individually actuatable in an automated manner by way of a digital actuation unit, with the mirrors being tilted between two predetermined orientations, which respectively correspond to an “ON” state and an “OFF” state, i.e. an activated state and non-activated state. Such micromirror fields are commercially available from Texas Instruments and are offered under the trademark “DLP” (standing for digital light processing). Previously, they were mainly used for digital image and video projections.

In some embodiments, a micromirror field is employed to spectrally form the excitation light beam in an emission spectrometer. As a result of the excitation light being spatially fanned out downstream of the first dispersive element, a spectral component, e.g. a small portion of the wavelength spectrum of the excitation light, is respectively assigned to a group of micromirrors in the process. Depending on the orientation of the micromirror field in the beam path, the activated state or the non-activated state of a micromirror then can lead to the partial beam incident thereon being selected. The partial beams selected thus are then refocused to form a common excitation beam in the second dispersive element, which is arranged adjacently in the beam path, such that substantially no fanning into individual spectral components is present anymore thereafter.

In some embodiments, the spectral fanning by the first dispersive element is therefore only introduced as an intermediate step in order to facilitate a spectral selection by the micromirror field and it is then undone again by the second dispersive element. The non-selected partial beams of the remaining micromirrors (in the respective reverse switching state) are deflected into a different direction such that they are coupled out of the excitation light beam. By way of the selection and spectral composition of the excitation light beam achieved thus, a very precise adaptation to the optical properties of the sample and to the respectively predetermined measurement object is facilitated. In some embodiments, it is also possible to switch over between different excitation spectra for different measurements in a particularly simple manner.

In some embodiments, a method includes selecting the spectral composition of the excitation light beam by means of activating and/or deactivating the individual micromirrors of the first micromirror field. Here, the described configurations of the emission-measuring device and of the measurement method may be advantageously combined with one another.

In some embodiments, the illumination unit of the emission-measuring device may have at least one focusing unit which is arranged between the radiation source and the first dispersive element in the beam direction. Alternatively, or additionally, such a focusing unit may be arranged between the second dispersive element and the sample region in the beam direction. Such focusing units may comprise e.g. optical lenses, lens systems, and/or concave mirrors. Thus, they may have e.g. at least one focusing lens or focusing mirror. Focusing the individual partial beams that correspond to the spectral components onto the various associated regions of the micromirror field can be achieved by a focusing unit that is arranged between the radiation source and the first dispersive element. This focusing allows a more precise spectral selection. A focusing unit that is additionally arranged between the second dispersive element and the sample region facilitates focusing of the typically divergent beam leaving the second dispersive element into a defined, collimated excitation light beam.

In some embodiments, optical stops may be arranged adjoining these, respectively upstream or downstream thereof in the beam path. By way of example, an input slit may be arranged downstream of the radiation-source-side focusing unit in order to facilitate a more precise imaging of the beam onto the micromirror field and, as a consequence, a more precise assignment of individual columns or lines of the micromirror field to the respective spectral components.

In some embodiments, the detection unit of the emission-measuring device may have a third dispersive element that is arranged downstream of the sample region in the beam direction, for decomposing the emitted radiation into its spectral components. Following this in the beam path, it may have a second micromirror field for selecting individual spectral components and following this in the beam path, in turn, it may have the radiation detector. Thus, the emission light emitted by the sample can be spectrally decomposed within the detection unit with the aid of the third dispersive element and then be spectrally selected with the aid of the second micromirror field in this embodiment.

In some embodiments, similar to the first micromirror field, this selection may be effectuated by virtue of the micromirrors which are assigned to a specific spectral component being activated and/or deactivated. The further beam path between the second micromirror field and the detector then can be aligned in such a way that, for example, the partial beams from the deactivated micromirrors or the partial beams from the activated micromirrors are deflected onto the detector. The partial beams of the respectively reversed activation state of the mirror can then be decoupled from the detection beam path accordingly. In principle, partial beams selected by the second micromirror field can be directed onto the radiation detector at the same time or else individually or successively in groups.

In some embodiments, there is a second micromirror field in the detection unit. In those, the shorter-wavelength spectral components of the excitation beam can be filtered out or the radiation incident into the detection unit prior to the detection by way of deselecting the corresponding micromirrors. The secondary radiation emitted by the sample, for example by fluorescence or phosphorescence, typically is displaced to longer light wavelengths in relation to the excitation light beam.

However, depending on the arrangement of the detection unit relative to the sample and relative to the beam path of the excitation beam, additionally reflected and/or scattered and hence spectrally non-displaced radiation components of the excitation light beam additionally also reach the detection unit. Therefore, spectral filtering within the detection unit is expedient to avoid a superposition of the longer wavelength emission radiation with the shorter wavelength excitation radiation. The use of the replaceable absorption filters, as used in the prior art, may be avoided by using a second micromirror field. Here, similar advantages come to bear as described above for the illumination unit in terms of replacing the absorption filters by the combination of dispersive element and micromirror field.

In some embodiments, the entire measuring device is adapted to the spectral properties of the sample to be examined in a particularly simple and precise manner by combining a first micromirror element in the illumination unit and a second micromirror element in the detection unit. In some embodiments, such an adaptation of the spectral filtering on the illumination and detection side is possible overall without moving macroscopic optical components and/or without using spectrally selective absorption filters.

The further configuration of the detection unit may differ depending on whether the emission-measuring device is an emission spectrometer or a device for imaging emission patterns, i.e. an emission microscope, for example. In an emission spectrometer, the detection unit may be configured for the spectrally resolved measurement of the emission intensity. To this end, the partial beams of the emission radiation that were already decomposed by the third dispersive element may remain fanned into their spectral components after the selection thereof by the micromirror field and may be steered to the imaging plane of a radiation detector in this way. The radiation detector may be e.g. a one-dimensional detector field or else a two-dimensional detector field, by means of which the partial beams of the different spectral components can be measured simultaneously. Thus, the intensities can be determined simultaneously for the entire emission spectrum or else for only a portion thereof.

In some embodiments, the radiation detector may have only a single detection channel and for the partial beams of the different spectral components selected by the micromirror field to be steered in succession to the detection surface of this individual detection channel. Then, the intensities for the various wavelength ranges thus can be measured successively. In the last-mentioned variant, the mode of operation of the second micromirror field for the spectral decomposition of the radiation to be measured may be similar to that of the spectrometer described above, with an additional effect of deselection, e.g. filtering an unwanted part of the spectrum, in particular of the short wavelength part of the detection beam which overlaps with the excitation spectrum.

In the case of an emission imager, e.g. an emission-measuring device for imaging a spatial emission distribution, a further dispersive element, e.g. a fourth dispersive element, may be arranged in the detection unit in the beam path between the second micromirror field and the radiation detector. This fourth dispersive element may unify the selected spectral components in a common filtered emission beam. This filtered emission beam then can be steered onto the radiation detector in such a way that a spatial image of the emitting sample is produced.

In some embodiments, the radiation detector may have a one-dimensional or two-dimensional pixelated sensor field, on the image plane of which the sample is imaged. In some embodiments, the image of the sample can be imaged in sequence on a single detector channel by scanning. In some embodiments, the detection unit may be provided with a magnifying optical unit, as a result of which the emission-measuring device can be used as an emission microscope, in particular as a fluorescence microscope.

In some embodiments, the emission-measuring device may comprise both as an emission spectrometer and as an emission imager. By way of example, this is possible by virtue of the partial beams leaving the second micromirror field remaining fanned in one spatial direction in accordance with a wavelength but being steered onto an image plane of the detector in the other spatial direction in such a way that information about the initial location of the emission radiation is obtained in this direction. To this end, the radiation detector may include a two-dimensional sensor field.

Like in the embodiments of the illumination unit comprising a focusing unit, the detection unit may also have one or more focusing units. Here too, these focusing units each may comprise at least one focusing lens and/or a concave mirror. In some embodiments, such a focusing unit may be arranged optically between the sample region and the third dispersive element to obtain focusing of the individual partial beams that correspond to the spectral components onto the various associated regions of the second micromirror field. This focusing allows a more precise spectral selection. In some embodiments, an additional focusing unit arranged between the second micromirror field and the radiation detector facilitates focusing in the direction of an image plane of the radiation detector of the beam that typically leaves the second micromirror field in a divergent manner. Such focusing allows either a more precise wavelength resolution in an emission spectrometer or a more precise spatial resolution in an emission imager.

Similar to the stops in certain embodiments of the illumination unit, the detection unit, too, may include one or more optical stops for improving the spectral resolution and/or the imaging quality. Hence, the detection unit can have an optical stop, e.g. a slit in the beam path upstream of the third dispersive element.

In some embodiments, the radiation detector may comprise only a single sensor channel. By way of example, this sensor channel may have a planar photodiode or photomultiplier. In some embodiments, the radiation detector generally may have a one-dimensionally or two-dimensionally pixelated sensor field. Here, this may be e.g. a CCD field, a pin-diode field, a CMOS sensor, and/or a focal plane array. In addition to silicon-based sensor materials, e.g. InGaAs (indium gallium arsenide) and MCT (mercury cadmium telluride) may be used as materials for the photosensor.

In some embodiments, the illumination unit and/or the detection unit may be free from spectrally selecting optical absorption filters.

The emission-measuring device may measure with the aid of visible light, ultraviolet radiation, and/or infrared radiation. That is to say, the radiation source can be a light source, an ultraviolet radiation source, and/or an infrared source. In some embodiments, the radiation source may comprise a radiation source that emits over a broad bandwidth, for example a broadband light-emitting diode or broadband laser, e.g. a quantum cascade laser or a halogen lamp.

In some embodiments, the emission-measuring device can be configured in such a way that radiation that is emitted by the sample is couplable into the detection unit with a directional component that opposes the direction of incidence of the excitation beam. Thus, the emission measurement can be configured as a measurement of the backwardly directed secondary radiation. By way of example, this can be achieved by arranging a beam splitter in the vicinity of the sample region, said beam splitter separating the optical path of the excitation beam and of the detection beam from one another.

In some embodiments, the emission-measuring device may have such a configuration that radiation that is emitted by the sample is couplable into the detection unit with a directional component corresponding to the direction of incidence of the excitation beam. To this end, the sample may be arranged geometrically between the excitation beam that impinges thereon and the part of the emission radiation that is couplable into the detection unit. Thus, this can be an arrangement for measuring the forward emission. In some embodiments, the emission-measuring device may couple in emission radiation with a main direction perpendicular to the direction of incidence of the excitation beam.

In some embodiments, a method for measuring light emission may include selecting a single contiguous portion of spectral components of the radiation by the first micromirror field and the remaining radiation can be coupled out of the further beam path. In other words, the first micromirror field can act as a band-pass filter in combination with the first dispersive element and the second dispersive element, said band-pass filter being used to select a predetermined contiguous wavelength range, e.g. a wavelength band. In some embodiments, such band-pass filtering of the excitation spectrum may be expedient for selecting for the excitation a spectral band which has an overlap with one or more absorption bands of the sample to be examined. The spectral components not required for exciting this sample may be masked in this way and, as a consequence, do not contribute to interfering optical effects in the further beam path. In some embodiments, a group of a plurality of spectral bands also can be selected by the first micromirror field in a similar manner.

In some embodiments, the first micromirror field can couple a single contiguous portion of spectral components of the radiation out of the beam path and the remaining radiation can be selected. In other words, the first micromirror field can act as a band-stop filter in combination with the first dispersive element and the second dispersive element, said band-stop filter masking a predetermined contiguous wavelength range, e.g. a wavelength band. This may mask a specific portion of the excitation spectrum which would be noticeable as particularly interfering over the further course of the beam path.

In some embodiments, all short wavelength spectral components of the radiation up to a set threshold of the wavelength can be selected by the first micromirror field and the remaining, longer wavelength radiation can be coupled out of the beam path. In other words, the first micromirror field can act as a short-pass filter in combination with the first dispersive element and the second dispersive element, said short-pass filter only passing the short wavelengths below a defined threshold into the further beam path. By way of example, this embodiment may guide into the sample region short wavelength radiation up to the longest wavelength absorption band of a sample to be excited.

In some embodiments, the first micromirror field can also select all long wavelength spectral components above a set threshold of the wavelength and the remaining radiation can be coupled out of the beam path. In other words, the first micromirror field can also can act as a long-pass filter in combination with the first dispersive element and the second dispersive element, said long-pass filter only passing the long wavelengths into the further beam path above a defined threshold.

In some embodiments, the radiation emitted by the sample may be selected spectrally by way of activation and/or deactivation using a second micromirror field arranged in the detection unit. In other words, a spectral filtering can also be undertaken in the detection unit by means of a micromirror field, for example to mask spectral components of the excitation radiation from the further course of the beam in the detection unit.

In the case of such spectral filtering within the detection unit, the profile of the filter set by the mirror positions also may correspond to a band-pass filter, a multi-pass filter, a band-stop filter, a short-pass filter, a long-pass filter, and/or a combination of the aforementioned filter types, just as described above for the illumination unit. In some embodiments, the second micromirror field can be actuated or set in such a way that band-pass filtering or long-pass filtering emerges for radiation that reaches into the detection unit in order thus to mask from the further course of the beam path, in particular from the region of the radiation detector, the short-wavelength spectral components that overlap with the excitation spectrum.

In some embodiments, the functions of the illumination unit and of the detection unit complement one another if, at least in one portion of the wavelength spectrum of the radiation, a selection pattern of the spectral components that are selected by the first micromirror field is complementary to a selection pattern of the spectral components that are selected by the second micromirror field. Such a configuration can be used to select, by means of the illumination unit, a short wavelength portion of the radiation that is emitted by the radiation source for the excitation of the sample and then filter out precisely this spectral portion upstream of the radiation detector to avoid an interfering superposition during the measurement of the emission radiation shifted to longer wavelengths.

In some embodiments, the long-wavelength spectral components in the region of the emission bands of the sample may be filtered out of the wavelength spectrum of the exciting radiation in the illumination unit as these typically do not contribute to exciting the emission. These long wavelength components then can be selected within the detection unit and steered to the radiation detector since they supply the main contribution to the desired signal. In some embodiments, the selection patterns of the first micromirror field and of the second micromirror field even may be substantially completely complementary to one another. However, in many cases, it is sufficient if such a complementary selection pattern is present in a portion of the wavelength spectrum of the radiation, for example in a region corresponding to the spectral absorption bands of the sample and/or the emission bands of the sample.

In some embodiments, the measurement method includes reconfiguring the emission-measuring device for a different wavelength range of the radiation that excites the emission and/or a different wavelength range of the emitted radiation, without moving macroscopic optical components. In some embodiments, this can be achieved by virtue of the spectral filtering that should be respectively matched to the sample being effectuated not by spectrally selective absorption filters but by digitally actuatable micromirror fields.

In some embodiments, the described filtering of the spectral component by the first micromirror field and/or the second micromirror field need not be effectuated in binary fashion as a complete selection or deselection of a given spectral component. Rather, it is also possible to set grayscales during filtering such that a certain spectral component can also be selected in portions. Such grayscales during the filtering can be realized in different ways:

In some embodiments, a partial selection of predetermined spectral components can be effectuated by selecting a predetermined fraction of the micromirrors in a line or column, assigned to the respective spectral component, of a two-dimensional first and/or second micromirror field. In other words, the spectral components can be steered onto a two-dimensional micromirror field with the aid of the respective dispersive element upstream thereof in such a way that the lines or columns of the mirror field respectively correspond to a spectral component, e.g. a specific wavelength range. The respective micromirrors of such a line or column that is illuminated approximately in monochrome fashion however need not necessarily have the same activation state. To implement a partial selection, a predetermined subset of the micromirrors in such a spectral subgroup (line or column) thus can also contribute to a selection of the corresponding spectral component. In principle, the differently switched micromirrors of such a subgroup may be either grouped according to activation state or else mixed in space.

In some embodiments, a partial selection of a spectral component can also be effectuated by a quickly repeated temporal change in the activation state of the individual micromirrors. This temporal change can be effectuated periodically and/or simultaneously for the micromirrors of a spectral subgroup. The precise portion of the spectral selection then is determined by the ratio between the time duration of the activated state and of the deactivated state.

In some embodiments, there is a softening of the selection of the component by way of the unsharpness when fanning open the respective optical beam into the various spectral components. As a rule, this also results in a not entirely complete selection or deselection of a certain spectral component in the practical implementation thereof, for example in the vicinity of the edge for the configuration of an edge filter, even if the subgroup associated with a certain spectral component is completely selected or deselected.

In some embodiments, the measurement method may include the spectrally resolved measurement of the light emission. Alternatively, or additionally, this can be a method for imaging a spatial distribution of the light emission. By way of example, it can be a method for emission microscopy.

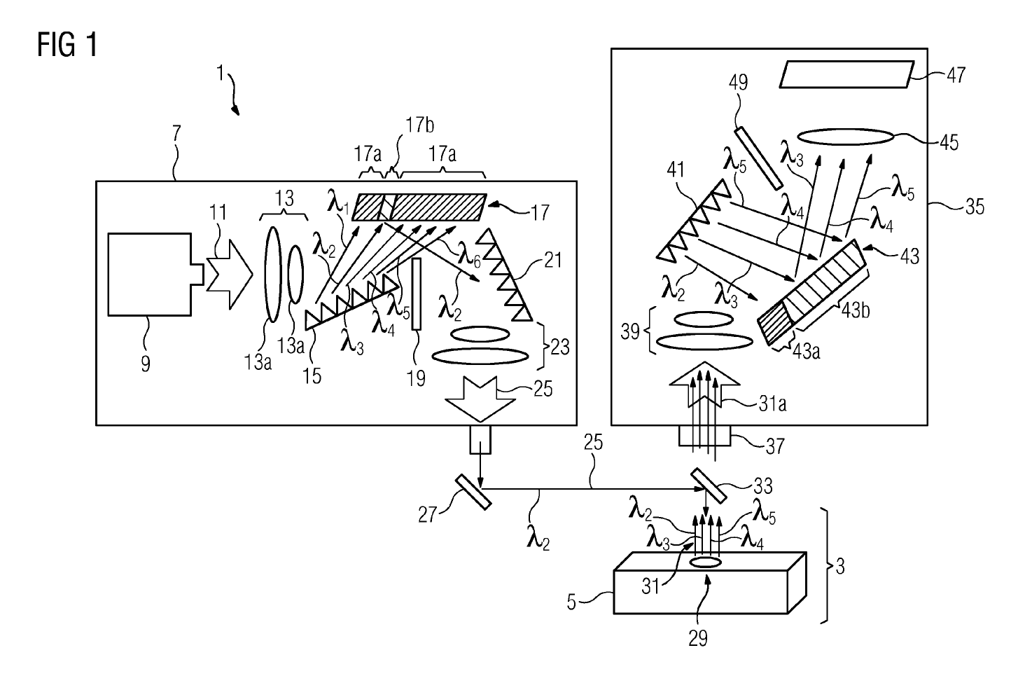

FIG. 1 shows a schematic block diagram of an emission-measuring device 1 according to the teachings of the present disclosure. Here, the emission-measuring device 1 is configured as a fluorescence spectrometer, by means of which the spectral composition of the fluorescence light that is emitted by a sample can be measured. The emission-measuring device 1 has an illumination unit 7 and a detection unit 35, the components of which are respectively represented in the associated blocks. Furthermore, the emission-measuring device 1 has a sample region 3, in which the sample 5 to be measured can be positioned. Below, the optical components of the emission-measuring device 1 are described substantially along the optical course of the beam.

Overall, the illumination unit 7 serves to provide an excitation beam 25 for irradiating the sample 5. To this end, radiation 11 that is emitted by a radiation source 9 is used, wherein this radiation can be visible light, infrared light, and/or ultraviolet radiation. The emitted radiation 11 is now spectrally filtered by various optical components. To this end, it is steered onto a first dispersive element 15 via a focusing unit 13. The focusing unit 13 serves to focus the radiation onto the first dispersive element 15. As shown schematically in FIG. 1, this focusing unit 13 may comprise, for example, a plurality of focusing lenses 13a. Thus, the radiation 11 is steered onto the first dispersive element 15 as a result thereof and the light is fanned out into its spectral components by way of the dispersive element 15. In an exemplary manner, FIG. 1 shows the course of the beam for six different spectral components λ₁ to λ₆.

A first micromirror field 17 is arranged downstream of the first dispersive element 15 in the beam path of the illumination unit 7. This first micromirror field 17 is a two-dimensional field of digitally actuatable micromirrors which can be switched between two defined states. Thus, the mirrors can be activated or deactivated; in other words, they can be ON or OFF. As a result of the first dispersive element 15, the radiation is spectrally fanned open in such a way that individual spectral components are substantially focused onto columns of the micromirror field 17. As illustrated in FIG. 1, these columns of the micromirror field 17 can be combined to individual deselected regions 17a and selected regions 17b. A selected region in this case corresponds to a mutually uniform splitting state of the micromirrors. The deselected region 17a then corresponds to the other state of the micromirrors.

In some embodiments, in the further course of the beam, the partial beams incident on the selected portion 17b are steered onto a second dispersive element 21. In FIG. 1, this pencil of rays is denoted by λ₂. However, this may not be a fixed wavelength but a portion of the wavelength spectrum of the emitted radiation 11. The other spectral components λ₁ and λ₃ to λ₆ are coupled out of the further course of the beam and, for example, steered to absorbers that are not illustrated in any more detail here or to any other radiation sink. A beam blocker 19 ensures that as little stray radiation as possible reaches the second dispersive element 21 on other radiation paths than the envisaged one. In conjunction with the first dispersive element 15, the micromirror field 17 thus acts as a band-pass filter in this case, by means of which only the portion of the spectrum λ₂ is selected. The slightly different wavelengths present in this portion λ₂ are refocused to a common excitation beam 25 by the second dispersive element 21. A second focusing unit 23 ensures a spatially well-defined beam profile of this excitation beam 25. Thus, overall, the illumination unit 7 has an optical filter unit, by means of which the spectral properties of the excitation beam 25 are set in a digitally actuated manner. No movable optical absorption filters are required to this end.

The further course of the excitation beam that is coupled out of the illumination unit 7 is denoted by 25a. It now substantially has the second spectral component λ₂. This excitation beam reaches the sample 5 to be measured via a mirror 27 and a beam splitter 33, said sample to be measured being able to positioned in a sample region 3 of the measuring device. Thus, this sample 5 is irradiated with the comparatively short wavelength spectral component λ₂ in a defined measurement region 29. Thereupon, the sample 5 emits longer wavelength radiation by way of fluorescence, for example having components λ₃ to λ₅. Moreover, stray radiation having the original wavelength λ₂ is superposed on these components. Together, this emission beam is denoted by the reference sign 31.

In some embodiments, it is coupled into the detection unit 35 through the beam splitter 33 and through an input gap 37. The detection unit 35 has a radiation detector 47 and a few more optical components which, together, likewise serve for spectral filtering of the coupled-in emission beam 31a. Initially, a third focusing unit 39 causes the coupled-in emission beam 31a to be focused onto a third dispersive element 41. Here too, the radiation is fanned open in accordance with its various spectral components λ₂ to λ₅ by this third dispersive element 41. The radiation that is fanned open in this way thus reaches different columns of a second micromirror field 43, split according to its spectral components. The latter is also a two-dimensional micromirror field to be actuated digitally, similar to the first micromirror field 17 of the illumination unit 7.

In the shown exemplary embodiment, the second micromirror field 43 is configured in such a way that a portion illuminated by the second spectral component λ₂ is a deselected portion 43a. The remaining spectral components λ₃ to λ₅ are incident on the second micromirror field 43 in a selected portion 43b. As a result, the components of the fluorescence light λ₃ to λ₅, which have a longer wavelength in comparison with the spectral component λ₂, are steered in the direction of the radiation detector 47 in the further course of the beam. A fourth focusing unit 45, for example a focusing lens, serves once again for the purposes of better focusing on this radiation detector 47. By contrast, the short wavelength spectral component λ₂ is coupled out of the further course of the beam and, for example, steered to a radiation sink that is not illustrated in any more detail here. Here too, a beam blocker 49 serves to avoid the incidence of unwanted stray light into the region of the radiation detector 47. Thus, within the detection unit 35, the second micromirror field 43 acts here together with the dispersive element 41 as a spectral filter, by means of which the spectral components of the excitation light beam λ₂ can be filtered out. Thus, the first micromirror field 17 and the second micromirror field 43 have a configuration that is complementary to one another, at least in the portion of the spectral component λ₂ and the longer wavelength components λ₃ to λ₅. What the spectral filtering within the detection unit 35 achieves is that the shorter wavelength spectral component λ₂ does not overexpose the measurement of the longer wavelength components λ₃ to λ₅ using the radiation detector 47.

In the embodiment of FIG. 1, the spectral components λ₃ to λ₅ to be measured are steered simultaneously onto the radiation detector 47. Expediently, this is a pixelated detected in this case, by means of which these individual spectral components can be measured in a spatially resolved manner. As a consequence, the measuring device of this first exemplary embodiment is suitable as an emission spectrometer. In some embodiments, in which the individual spectral components λ₂ to λ₅ are measured simultaneously, these spectral components can also be selected temporally in succession by the second micromirror field 43 and thus be steered in succession to the radiation detector 47. Further, the radiation detector 47 may be a single detector channel, said detector channel not measuring in a spatially resolved manner but measuring the various spectral components with a time offset. To this end, the second micromirror field 43 may then be operated as a band-pass filter with a temporally variable wavelength setting.

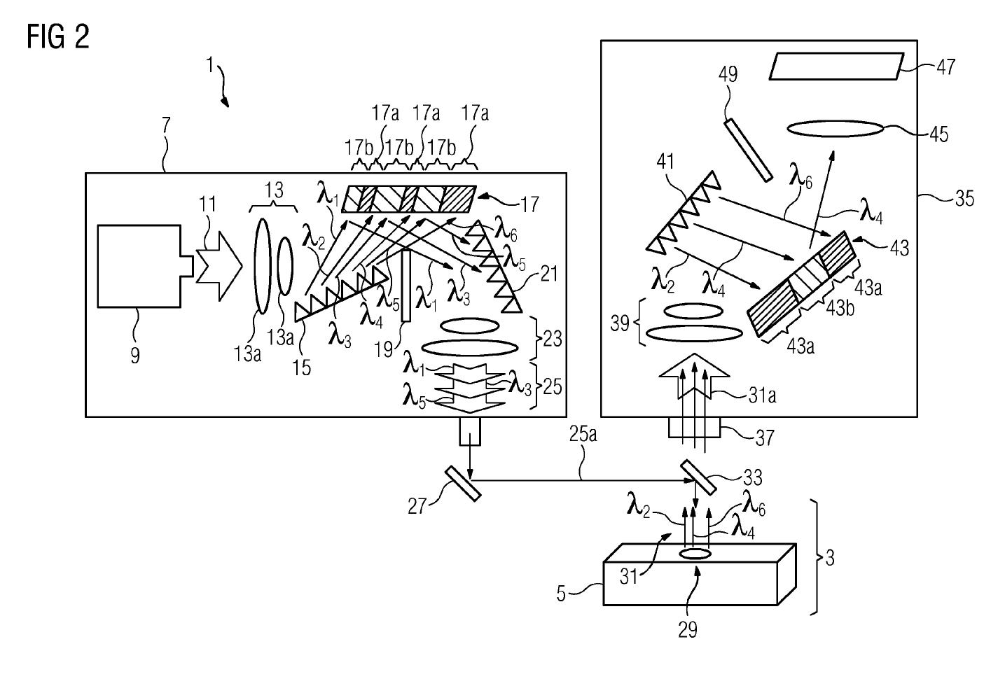

FIG. 2 shows a schematic block diagram of an emission-measuring device 1 according to a second exemplary embodiment of the invention. Components that are similar or have the same effect have been provided with the same reference sign as in FIG. 1 in this case. Here too, an excitation beam 25 is coupled out of an illumination unit 7 and steered onto a sample 5 to be measured. From there, the radiation emitted by the sample is coupled into a detection unit 35 through the input gap 37, said radiation being measured by a radiation detector 47 in said detection unit. The essential differences from the first exemplary embodiment lie in the configuration of the two micromirror fields 17 and 43.

In some embodiments, the first micromirror field 17 acts as a multi-pass filter together with the first dispersive element 15. Present are three individual selected portions 17b, within which the micromirrors deflect the impinging radiation further in the direction of the second dispersive element 21. Thus, three different wavelength bands corresponding to the three spectral components λ₁, λ₃ and λ₅ are selected from the relatively broad spectrum of the radiation 11 emitted by the radiation source 9. By contrast, the remaining components λ₂, λ₄ and λ₆, shown schematically here, are coupled out of the beam path. Here, the second dispersive element 21 refocuses the three selected wavelength components λ₁, λ₃ and λ₅ to form an excitation beam 25 that propagates together. The excitation beam 25a that is coupled out of the illumination unit 7 is steered onto the sample 5, in which different emission mechanisms can be excited by the three spectral components of the excitation beam. Thus, for example, various chemical constituents of the sample 5 can be excited to emit in the style of a multichannel excitation by way of the different spectral components λ₁, λ₃ and λ₅.

In some embodiments, the spectral components can be adapted in a targeted manner to the chemical compounds to be examined by way of the digitally actuatable first micromirror field. By way of example, the sample 5 may contain three different components which, by way of the three spectral components of the excitation beam 25a, can each be excited to fluoresce slightly shifted toward longer wavelengths. Thus, there is a light emission with three new spectral components λ₂, λ₄ and λ₆. Then, the emission beam 31 formed thus can be coupled, once again, into the detection unit 35 via the beam splitter 33 and the input gap 37. The spectral components of the emission λ₂, λ₄ and λ₆ are also superposed on the spectral components of the excitation λ₁, λ₃ and λ₅ as scattered radiation components in this example. However, these components have not also been plotted in the emission beam 31 for reasons of clarity.

In some embodiments, the detection unit 35 has a third dispersive element 41 and a second micromirror field 43 which, together, bring about spectral filtering of the coupled-in emission beam 31a. The three spectral components λ₂, λ₄ and λ₆ of the emitted radiation can be selected e.g. successively by the second micromirror field 43. The configuration shown in FIG. 2 corresponds to a selection of the spectral component λ₄, wherein the remaining components λ₂ and λ₆ are coupled out of the further course of the beam by the non-selected regions 43a of the second micromirror field 43. For reasons of clarity, the spectral components λ₁, λ₃ and λ₅ of the excitation light beam have no longer been plotted within the detection unit 35 in FIG. 2. However, parts of the excitation light beam can also reach into the detection unit 35 in this case too, for example by light scattering, and can also be coupled out of the further course of the beam by an adaptation of the configuration of the second micromirror field 43 such that these components of the excitation light beam do not reach up to the radiation detector 47 either.

In some embodiments, the spectral components λ₂, λ₄ and λ₆ to be measured by the radiation detector 47 can also be steered onto the radiation detector 47 simultaneously and/or in succession. In some embodiments, such emission-measuring devices 1 may also be operated as imaging measuring devices. To this end, a further dispersive element can be disposed downstream of the second micromirror field 43 within the detection unit 35, said further dispersive element once again focusing the selected spectral components of the emission beam to form common partial beams, as a result of which a spatial image of a surface of the sample 5 can be produced on the radiation detector 47.

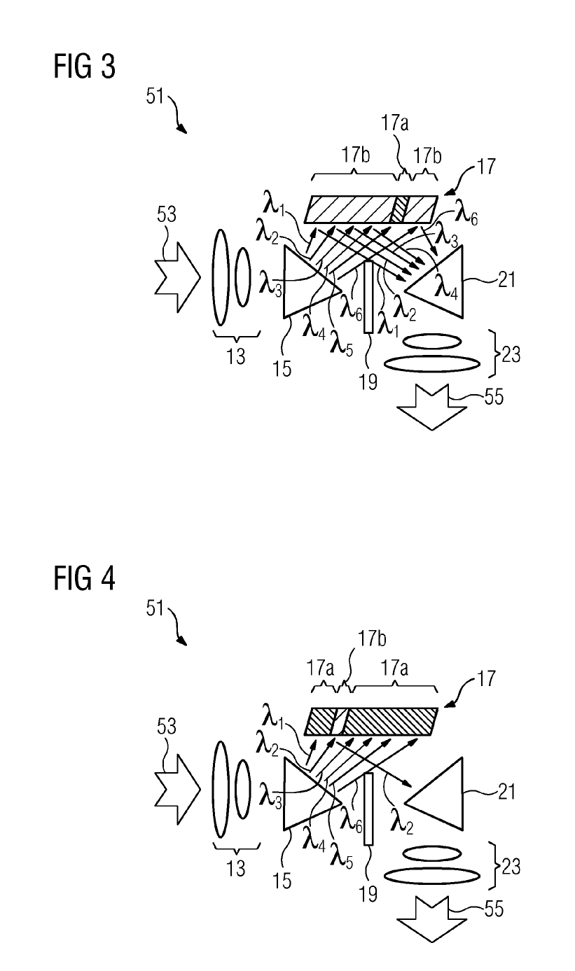

The following four figures illustrate four further exemplary embodiments; however, these do not show complete emission-measuring devices but individual optical filter units 51 which can be used as optical filter units in the illumination unit and/or in the detection unit like in the exemplary embodiments already described above. Here, FIGS. 3 to 6 respectively show similar optical components; however, the actuation of the micromirror field 17 is configured differently.

FIG. 3 shows an optical filter unit 51, in which the radiation of an input beam 53 is spectrally selected. Thus, it is possible to produce an output beam 55 with an adjustable spectral composition. The input beam is steered onto a first dispersive element 15 by a focusing unit 13. This dispersive element 15 fans open the radiation into its individual spectral components, illustrated here in an exemplary manner by λ₁ to λ₆.

In some embodiments, the partial beams of these individual spectral components impinge on a micromirror field 17, the micromirrors of which mainly have a selecting switching state. Flanked by two selected portions 17b, a single deselected portion 17a is set, the associated micromirrors coupling the impinging radiation out of the further beam path and, as a consequence, also out of the output beam 55 in said deselected portion. This deselected portion 17a will relate accordingly to the fifth spectral component λ₅ of the radiation.

In some embodiments, the remaining spectral components λ₁ to λ₄ and λ₆ are subsequently refocused to form a common output beam 55 by the second dispersive element 21, the spectral component of said common output beam now having been reduced by the deselected spectral component λ₅. Thus, overall, the shown configuration is a band-stop filter. When the optical filter unit 51 is used in a detection unit, it is also possible to dispense with the second dispersive element 21 if the various spectral components no longer need to be focused into a common optical beam before the detection. This also applies to the following exemplary embodiment of the optical filter units 51.

FIG. 4 shows a further optical filter unit 51 according to a fourth exemplary embodiment. This filter unit 51 differs from the preceding exemplary embodiment by the configuration of the micromirror field 17. Here, the micromirror field 17 is switched in such a way that only a single selected portion 17b emerges, flanked by two large-area deselected portions 17a. Thus, only a relatively small section of the spectrum of the input beam 53 is filtered through to the output beam 55 in this case. In the schematically shown example of FIG. 4, this is the exemplary spectral component λ₂ from the set of the original spectral components λ₁ to λ₆. The remaining spectral components λ₁ and λ₃ to λ₆ are steered onto a radiation sink, not shown here, by way of the deselected portions 17a of the micromirror field 17 and are therefore no longer available for the output beam 55. Thus, a band-pass filter can be configured in a simple manner.

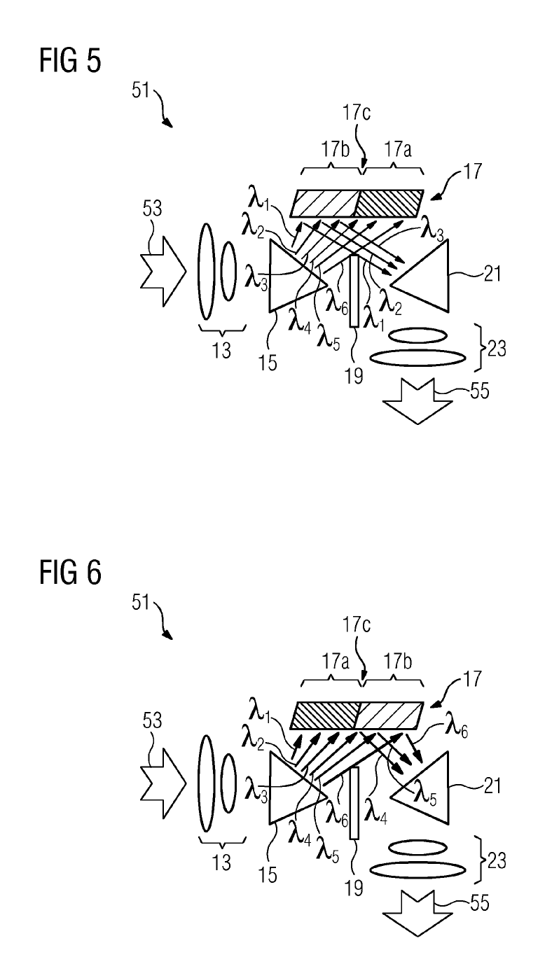

FIG. 5 shows a similar optical filter element 51 in a further exemplary configuration. Here, the micromirror field 17 acts as an edge filter together with the dispersive elements 15 and 21, with radiation with wavelengths below a spectral edge 17c being passed. Thus, the micromirror field 17 only has a selected portion 17b and a deselected portion 17a, with the selected portion 17b being assigned to the shorter wavelength spectral components λ₁ to λ₃. Accordingly, these shorter wavelength components λ₁ to λ₃ are mixed together to form the output beam 55.

FIG. 6 shows a further exemplary embodiment of an optical filter unit 51 which is configured as an optical edge filter in turn. Here too, an edge 17c forms the separating line between a deselected portion 17a and a selected portion 17b of the micromirror field. In this example, the selected portion 17b corresponds to the longer wavelength components λ₄ to λ₆ of the input beam 53, and so the optical filter element acts as a long-pass filter overall.

What is claimed is:

1. An emission-measuring device comprising:
a sample region;
an illumination unit for irradiating the sample region and a sample positioned therein; and
a detection unit comprising a radiation detector for detecting radiation emitted by the sample once irradiated;
wherein the illumination unit includes:
a radiation source;
a first dispersive element arranged downstream of the radiation source in a beam direction, the first dispersive element decomposing the radiation into its spectral components;
a first micromirror field arranged downstream of the first dispersive element in the beam direction; and
a second dispersive element arranged downstream of the first micromirror field in the beam direction;
wherein the second dispersive element unifies spectral components selected by the first micromirrror field into a common excitation beam.

2. The emission-measuring device as claimed in claim 1, wherein the illumination unit further comprises a focusing unit arranged between the radiation source and the first dispersive element and/or between the second dispersive element and the sample region.

3. The emission-measuring device as claimed in claim 1, wherein the detection unit further comprises:
a third dispersive element arranged downstream of the sample region in the beam direction and decomposing the emitted radiation into its spectral components;
a second micromirror field arranged downstream of the third dispersive element in the beam direction, for selecting individual spectral components; and
a radiation detector arranged downstream of the second micromirror field in the beam direction.

4. The emission-measuring device as claimed in claim 3, wherein the detection unit further comprises a focusing unit arranged between the sample region and the third dispersive element in the beam direction and/or arranged between the second micromirror field and the radiation detector in the beam direction.

5. The emission-measuring device as claimed in claim 1, wherein the radiation detector comprises a single sensor channel.

6. The emission-measuring device as claimed in claim 1, wherein the radiation detector comprises a sensor field pixelated in one or two dimensions.

7. The emission-measuring device as claimed in claim 1, wherein the illumination unit and/or the detection unit comprises no spectrally selecting optical absorption filters.

8. A method comprising:
irradiating a sample region and a sample positioned therein with an illumination unit;
using a radiation detector for detecting radiation emitted by the sample once irradiated;
wherein the illumination unit includes: a radiation source; a first dispersive element arranged downstream of the radiation source in a beam direction, the first dispersive element decomposing the radiation into its spectral components;
a first micromirror field arranged downstream of the first dispersive element in the beam direction; and a second dispersive element arranged downstream of the first micromirror field in the beam direction;
wherein the second dispersive element unifies spectral components selected by the first micromirrror field into a common excitation beam; and
selecting the spectral composition of the excitation beam by activating and/or deactivating the individual micromirrors of the first micromirror field.

9. The method as claimed in claim 8, further comprising:
selecting a single contiguous portion of spectral components of the radiation by the first micromirror field; and
coupling the remaining radiation out of the beam path; or
coupling a single contiguous portion of spectral components of the radiation out of the beam path by the first micromirror field and selecting the remaining radiation.

10. The method as claimed in claim 8, further comprising:
selecting all short wavelength spectral components of the radiation up to a set threshold of the wavelength by the first micromirror field and coupling the remaining radiation out of the beam path; or
selecting all long wavelength spectral components above a set threshold of the wavelength by the first micromirror field and coupling the remaining radiation out of the beam path.

11. The method as claimed in 8, further comprising spectrally selecting the radiation emitted by the sample by means of a second micromirror field arranged in the detection unit by activating and/or deactivating individual micromirrors.

12. The method as claimed in claim 11, further comprising selecting a pattern of the spectral components by the first micromirror field complementary to a selection pattern of the spectral components selected by the second micromirror field, at least in a portion of the wavelength spectrum.

13. The method as claimed in claim 8, further comprising reconfiguring the emission-measuring device for a different wavelength range of the radiation exciting the emission and/or a different wavelength range of the emitted radiation without moving macroscopic optical components.

14. The method as claimed in claim 8, further comprising effectuating a partial selection of predetermined spectral components by repeated switching between an activated state and a deactivated state of mirrors of the first and/or second micromirror field.

15. The method as claimed in claim 8, further comprising effectuating a partial selection of predetermined spectral components by selecting a predetermined fraction of the micromirrors in a line or column of a two-dimensional first and/or second micromirror field assigned to the respective spectral component.
